(19) United States
(12) Patent Application Publication
(10) Pub. No.: US 2013/0273997 A1
(43) Pub. Date: Oct. 17, 2013

(54) SYSTEMS, METHODS AND DEVICES FOR PLAYING WAGERING GAMES WITH PLAYER-CONTROLLED VOLATILITY-CHANGING MECHANISMS

(71) Applicant: WMS GAMING INC., Waukegan, IL (US)

(72) Inventor: James Stewart, Red Hill (AU)

(73) Assignee: WMS Gaming Inc., Waukegan, IL (US)

(21) Appl. No.: 13/770,358

(22) Filed: Feb. 19, 2013

Related U.S. Application Data
(60) Provisional application No. 61/624,455, filed on Apr. 16, 2012.

(51) Int. Cl. G07F 17/34

(52) U.S. Cl. CPC G07F 17/34
USPC 463/21; 463/20

(57) ABSTRACT

Gaming devices, gaming systems, methods of conducting wagering games, and computer programs for executing wagering games are disclosed. A gaming system for conducting a wagering game is disclosed which includes memory device(s) which stores instructions which cause processor(s) to operate with display device(s) and input device(s) to: receive a wager to play the wagering game, which includes numerous symbol-bearing reels; display various player-selectable volatility-changing reel modifiers, each of which is associated with one of the symbol-bearing reels and configured to modify the volatility of the subsequent play of the wagering game in a distinct manner; receive a player's selection from the displayed volatility-changing reel modifiers; modify the volatility of the subsequent play of the wagering game in the manner associated with the selected volatility-changing reel modifier; display a randomly determined outcome of the subsequent play of the wagering game; and, determine if the subsequent-play outcome includes any winning symbol combinations.

### CLAIM OF PRIORITY AND CROSS-REFERENCE TO RELATED APPLICATION

This application claims the benefit of and priority to U.S. Provisional Patent Application No. 61/624,455, which was filed on Apr. 16, 2012, and is incorporated herein by reference in its entirety.

### COPYRIGHT

A portion of the disclosure of this patent document contains material which is subject to copyright protection. The copyright owner has no objection to the facsimile reproduction by anyone of the patent disclosure as it appears in the U.S. Patent and Trademark Office patent files or records, but

### TECHNICAL FIELD

The present disclosure relates generally to wagering games, as well as wagering game terminals and gaming systems. More particularly, the present disclosure relates to systems, methods, and devices for playing wagering games with changing volatilities.

### BACKGROUND

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Thus, gaming manufacturers continuously strive to develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “primary” or “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Wagering games may additionally award players with “progressive jackpot” awards that are funded, at least in part, by a percentage of coin-in from the gaming machine or a plurality of participating gaming machines.

One type of bonus game presents the player with an assemblage of player-selectable symbols, the selection of which reveals a bonus-credit award that is initially concealed by the symbol. The player continues to make selections and accumulate awards until an end-bonus outcome is uncovered or all of the player-selectable symbols have been chosen. Thus, if a player initially selects a symbol covering the end-bonus outcome, the player receives no bonus award. This selection-type bonus game, wherein a selection may award credits or end the game, is generally considered to have a high volatility index. “Volatility index” is a mathematical value that is the industry standard for measuring the distribution of sizes and probabilities of slot machine payoffs. Put another way, “volatility” can be considered a measure of the expected payback, i.e., the size and frequency of awards, of a particular wagering game. Some games pay out more often in smaller amounts; such games are considered to be a “low volatility” game. Some games pay out less often in larger amounts; such games are considered to be a “high volatility” game. Most standard base wagering games have a relatively constant, low volatility index. On the other hand, the above-described selection-type bonus game has a relatively constant, high volatility index. Volatility is described in further detail in commonly owned U.S. Pat. No. 6,302,791, to Erica A. Frohm et al., which is incorporated herein by reference in its entirety and for all purposes.

While some current game features provide some enhanced excitement, there is still a need for additional concepts to enhance the entertainment value of electronic wagering games, such as slots, keno, poker, and blackjack. Although a lot of focus is now being paid to enhancing bonus games, there is still room for improving aspects of the basic wagering game. Such new features for wagering games will further enhance player excitement, perpetuate player loyalty, and thus increase game play and profitability.

### SUMMARY

Aspects of the present disclosure are directed to multi-reel slot-type wagering games that utilize a number of multiplier tabs, each of which is assigned to an individual reel. The multiplier applies to all line wins that include a symbol on the reel associated with the selected multiplier tab. In this instance, the volatility of the slot-type wagering game is increased if the player selects a higher multiplier tab. Aspects of the present disclosure are also directed to a slot-type wagering game with a multi-reel symbol array including multiple rows having a plurality of different column sizes. The player is prompted to select and move one or more of the reels. In this instance, the volatility of the slot-type wagering game changes depending on the selected reel(s) and the location to which the reel(s) is moved.

According to one aspect of the present disclosure, a gaming system for conducting a wagering game is disclosed. The gaming system includes at least one input device, at least one display device, and at least one processor. The gaming system also includes at least one memory device that stores instructions which, when executed by the at least one processor, cause the gaming system to: receive a wager to play the wagering game, the wagering game including a plurality of symbol-bearing reels; display a plurality of player-selectable volatility-changing reel modifiers, each of which is selectable by a player, associated with a respective one of the symbol-bearing reels, and configured to modify a volatility of a subsequent play of the wagering game in a distinct manner; receive from a player a selection of at least one of the player-selectable volatility-changing reel modifiers; modify the volatility of the subsequent play of the wagering game according to the distinct manner associated with the selected volatility-changing reel modifier; display a randomly determined outcome of the subsequent play of the wagering game; and, determine if the subsequent-play outcome includes at least one of a plurality of winning symbol combinations.

Other aspects of the present disclosure are directed to a method of conducting a wagering game on a gaming system with at least one input device, at least one display device, and at least one processor. The wagering game includes a plurality of symbol-bearing reels. The method includes: receiving, via the at least one input device, an indication of a wager; displaying, via the at least one display device, a plurality of player-selectable volatility-changing reel modifiers, each of which is associated with a respective one of the symbol-bearing reels and configured to modify a volatility of a subsequent play of the wagering game in a distinct manner; receiving, via the at least one input device, a player selection of at least one of the player-selectable volatility-changing reel modifiers; modifying, via the at least one processor, the volatility of the subsequent play of the wagering game according to the distinct manner associated with the selected volatility-changing reel modifier; displaying, via the at least one display device, a randomly determined outcome of the subsequent play of the wagering game; and, determining, via the at least one processor, if the subsequent-play outcome includes at least one of a plurality of winning symbol combinations.

According to another aspect of the disclosure, a computer program product is disclosed which includes one or more non-transient computer-readable media with instructions which, when executed by one or more processors, cause the one or more processors to operate with one or more input devices and one or more display devices to: receive a wager to play the wagering game, the wagering game including a plurality of symbol-bearing reels; display a plurality of player-selectable volatility-changing reel modifiers, each of the player-selectable volatility-changing reel modifiers being associated with a respective one of the symbol-bearing reels and configured to modify a volatility of a subsequent play of the wagering game in a distinct manner; receive from a player a selection of at least one of the player-selectable volatility-changing reel modifiers; modify the volatility of the subsequent play of the wagering game according to the distinct manner associated with the selected volatility-changing reel modifier; and, display a randomly determined outcome of the subsequent play of the wagering game.

Another aspect of this disclosure is directed to a gaming system for playing a wagering game. The gaming system includes, inter alia, at least one input device, at least one display device, at least one processor, and at least one memory device. The memory device(s) stores instructions which, when executed by the processor(s), cause the gaming system to: receive, responsive to a wager input via the at least one input device, a wager to play the wagering game, the wagering game including a plurality of symbol-bearing reels arranged in an array from left-to-right; display, via the at least one display device, a plurality of player-selectable volatility-changing reel award multipliers, each of the player-selectable reel award multipliers being assigned to a respective one of the symbol-bearing reels and configured to multiply an award value associated with each winning symbol combination in a subsequent play of the wagering game which includes a symbol on the symbol-bearing reel assigned to the selected volatility-changing reel award multiplier; receive, responsive to a player input via the at least one input device, a selection of at least one of the volatility-changing reel award multipliers; display, via the at least one display device, an outcome of the subsequent play of the wagering game, the subsequent-play outcome being randomly determined from a plurality of wagering-game outcomes; and determine if the subsequent-play outcome includes at least one of a plurality of winning symbol combinations, the determining including evaluating at least one active payline extending through the plurality of symbol-bearing reels on a left-to-right line pay scheme.

Yet another aspect of the disclosure presents a gaming system for playing a wagering game. This gaming system includes, inter alia, at least one input device, at least one display device, at least one processor, and at least one memory device. The memory device(s) stores instructions which, when executed by processor(s), cause the gaming system to: receive, responsive to a wager input via the at least one input device, a wager to play the wagering game, the wagering game including a plurality of symbol-bearing reels arranged in an array from left-to-right, and a plurality of distinct-sized windows each of which shows therethrough a portion of a respective one of the symbol-bearing reels; receive, responsive to a player input via the at least one input device, a selection to move at least one of the symbol-bearing reels and the corresponding distinct-sized window from a current location to a new location; modifying a volatility of a subsequent play of the wagering game according to the new location of the moved symbol-bearing reel and distinct-sized window; display, via the at least one display device, an outcome of the subsequent play of the wagering game, the subsequent-play outcome being randomly determined from a plurality of wagering-game outcomes; and determine if the subsequent-play outcome includes at least one of a plurality of winning symbol combinations, the determining including evaluating at least one active payline extending through the plurality of symbol-bearing reels on a left-to-right line pay scheme.

The above summary is not intended to represent each embodiment or every aspect of the present disclosure. Rather, the summary merely provides an exemplification of some of the novel features presented herein. The above features and advantages, and other features and advantages of the present disclosure, will be readily apparent from the following detailed description of exemplary embodiments and modes for carrying out the present invention when taken in connection with the accompanying drawings and the appended claims.

### BRIEF DESCRIPTION OF THE DRAWINGS

FIG. 1 is a perspective-view illustration of an exemplary free-standing gaming terminal according to aspects of the present disclosure.

FIG. 2 is a schematic diagram of an example of a gaming system according to aspects of the present disclosure.

FIG. 3 is a screen shot of a representative basic-game screen of a wagering game displayed on a gaming terminal, gaming device, and/or gaming system according to aspects of the present disclosure.

FIG. 4 is a screen shot of a display device displaying an exemplary wagering game with a number of player-selectable volatility-changing mechanisms in accordance with aspects of the present disclosure.

FIG. 5 is a screen shot of a display device displaying the exemplary wagering game of FIG. 4 showing a selected one of the player-selectable volatility-changing mechanisms changing the volatility of a subsequent play of the wagering game in a distinct manner.

FIG. 6 is a screen shot of a display device displaying the exemplary wagering game of FIG. 4 showing another selected one of the player-selectable volatility-changing mechanisms changing the volatility of a subsequent play of the wagering game in a distinct manner.

FIG. 7 is a screen shot of a display device displaying another exemplary wagering game with a number of player-selectable volatility-changing mechanisms in accordance with aspects of the present disclosure.

FIG. 8 is a screen shot of a display device displaying the exemplary wagering game of FIG. 7 showing one of the player-selectable volatility-changing mechanisms being selected and changing the volatility of a subsequent play of the wagering game in a distinct manner.

FIG. 9 is a screen shot of a display device displaying the exemplary wagering game of FIG. 8 with the wagering being modified in response to the selected player-selectable volatility-changing mechanism.

FIG. 10 is a screen shot of a display device displaying the exemplary wagering game of FIG. 7 showing a number of the player-selectable volatility-changing mechanisms being selected and changing the volatility of a subsequent play of the wagering game in a distinct manner.

FIG. 11 is a flowchart of an exemplary method or algorithm that can correspond to instructions that can be stored on one or more non-transitory computer-readable media and can be executed by one or more controllers in accord with aspects of the disclosed concepts.

While aspects of this disclosure are susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

This invention is susceptible of embodiment in many different forms. There are shown in the drawings and will herein be described in detail representative embodiments of the invention with the understanding that the present disclosure is to be considered as an exemplification of the principles of the invention and is not intended to limit the broad aspects of the invention to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the word “including” means “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.

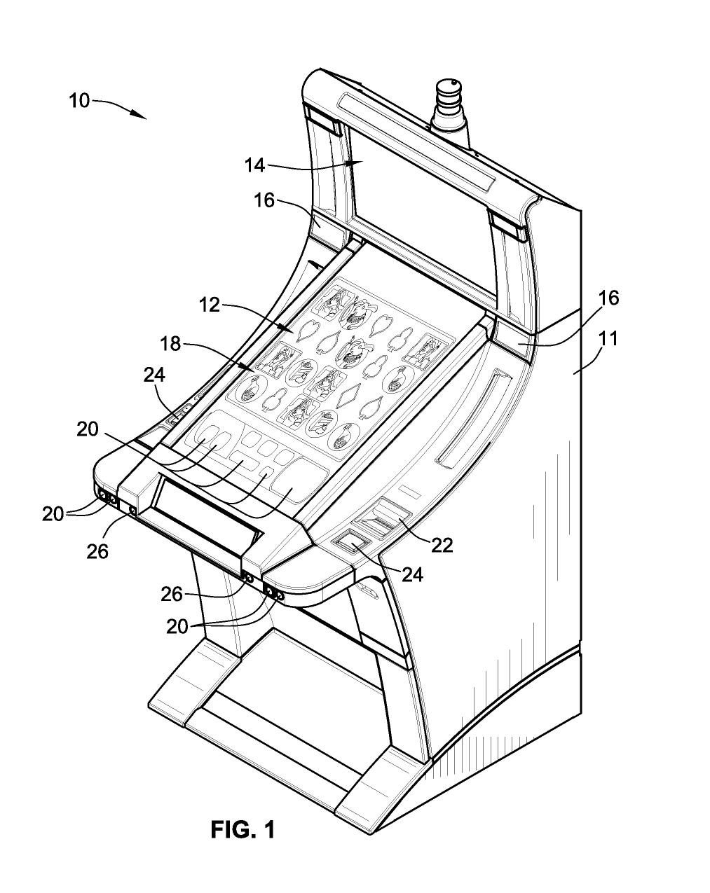

Referring to the drawings, wherein like reference numerals refer to like features throughout the several views, there is shown in FIG. 1 a representative gaming terminal 10 similar to those used in gaming establishments, such as casinos, hotels and cruise ships, and non-conventional gaming establishments, such as airports and restaurants. With regard to the present disclosure, the gaming terminal 10 may be any type of gaming terminal and may have varying structures and methods of operation. For example, in some aspects, the gaming terminal 10 is an electromechanical gaming terminal configured to play slots with mechanical reels, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models (as shown), handheld mobile devices, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed, for example, in U.S. Pat. No. 6,517,433, U.S. Patent Application Publication Nos. US2010/0069160 and 2010/0234099, and International Application No. PCT/US2007/000792, all of which are incorporated herein by reference in their respective entireties and for all purposes.

The gaming terminal 10 illustrated in FIG. 1 comprises a cabinet 11 that may house various input devices, output devices, and input/output devices. By way of non-limiting example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display may be disposed in front of the mechanical-reel display to portray a video image superimposed upon the mechanical-reel display. The display areas may variously display information associated with wagering games, non-wagering games, community games, progressive games, advertisements, services, premium entertainment, text messaging, emails, alerts, announcements, broadcast information, subscription information, etc., appropriate to the particular mode(s) of operation of the gaming terminal 10. The gaming terminal 10 includes a touch screen(s) 18 mounted over the primary and/or secondary areas 12, 14, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals can be selected from a group consisting essentially of an electrical current, an electrical voltage, an electrical charge, an optical signal, an optical element, a magnetic signal, and a magnetic element.

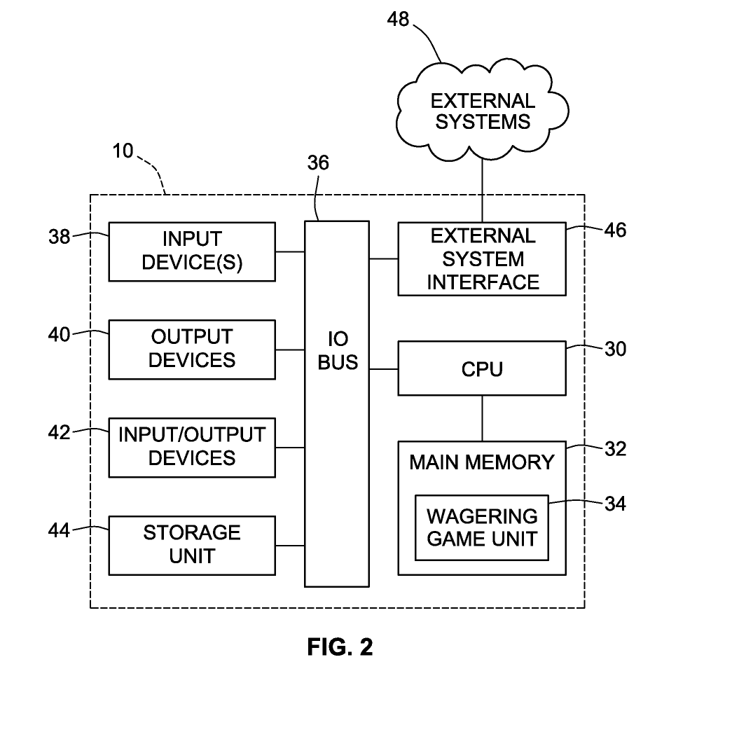

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

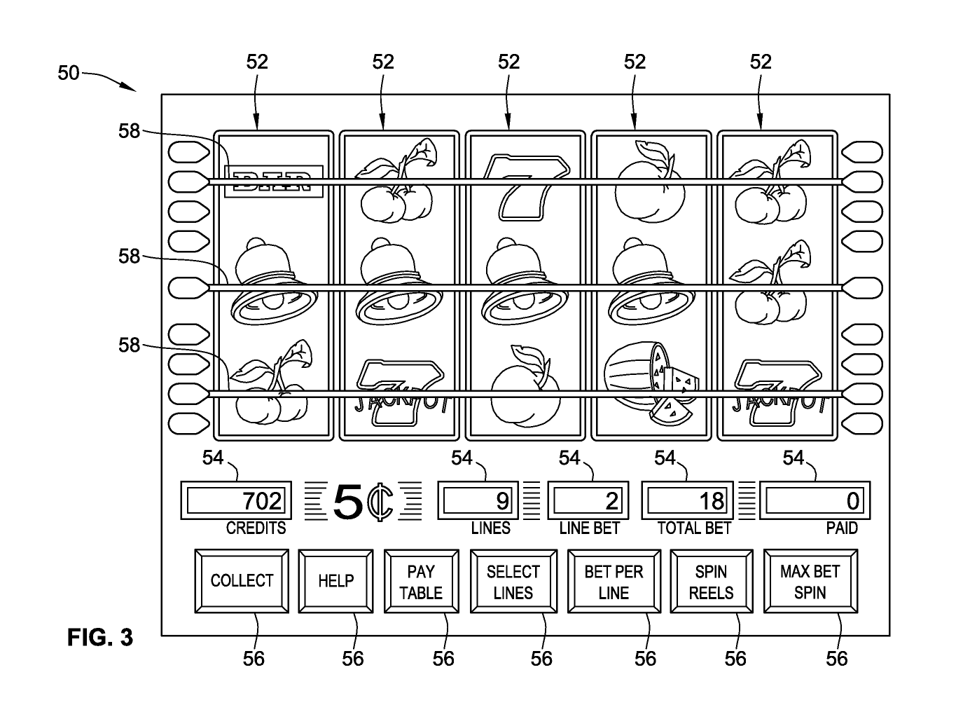

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

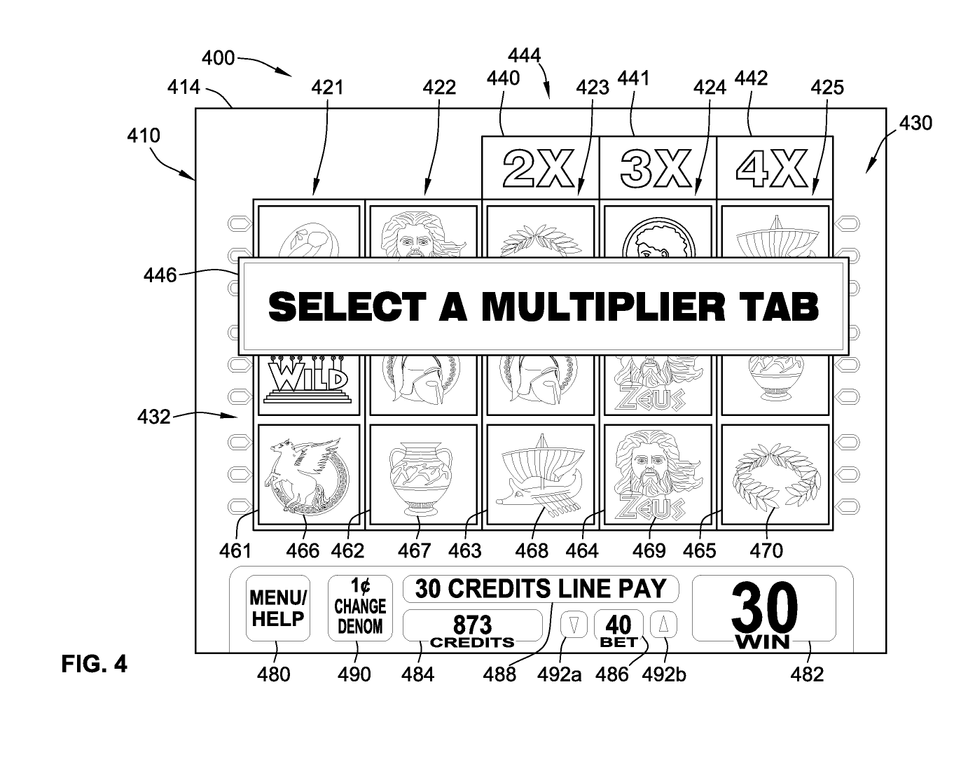

FIG. 4 is a screen shot of a game screen from an exemplary wagering game in accordance with aspects of the present disclosure. A primary display 414 of a gaming device or terminal 410, which may be part of an exemplary gaming system 400, is shown is FIG. 4. The gaming system 400 may be similarly configured to the gaming system shown in FIG. 2. The gaming terminal 410 of FIG. 4 can take on various configurations, including, without limitation, upright freestanding gaming machines, slant-top freestanding gaming machines, handheld and portable gaming machines, countertop gaming machines, personal computers and laptop computers, or other known gaming devices, individually or in any combination thereof. The primary display device 414 of the gaming terminal 410 displays wagering games, such as those described above with respect to FIGS. 1-3 or those described below with respect to FIGS. 4-11, for example. The display device 414 may be any form of display, such as those described with reference to the free-standing gaming terminal 10 of FIG. 1. For instance, the primary display 414 may comprise a plasma, LED, OLED, LCD, CRT, projection, or any other now-known or later-developed display device. Although numerous aspects of the wagering game 430 are all shown displayed on a single display device (i.e., the primary display 414), these aspects are not so limited and can be displayed in any combination on any number of display devices unless otherwise expressly prohibited.

The display device 414 displays or otherwise visually depicts a wagering game 430, which in this example is the slot game shown in FIG. 4. The slot game 430 includes a plurality of vertically oriented, horizontally aligned symbol-bearing reels, designated generally as 421-425, respectively, each having a plurality of distinct symbol positions (collectively represented by the five symbol positions 461-465 in the third row of the array 432) and bearing a number of symbols (collectively represented by the five symbols 466-470 in the third row of the array 432). The symbols may include any variety of graphical symbols, emblems, elements, or representations, including symbols that are associated with one or more themes of the gaming terminal 410 and gaming system 400 (e.g., Greek Mythology). The symbols may also include a blank symbol or empty space. The symbols on the reels 421-425 are arranged in an array 432, which in this embodiment is a 3×5 matrix (i.e., three rows by five columns) of symbols. The reels 421-425 are varied (e.g., spun and stopped) to reveal combinations of symbols in the array 432, which represent randomly selected outcomes of the wagering game 430, that are evaluated for winning symbol combinations. Winning combinations of symbols landing, for example, on activated paylines (e.g., those paylines for which a wager has been received), cause awards to be paid in accordance with one or more pay tables associated with the gaming system 400.

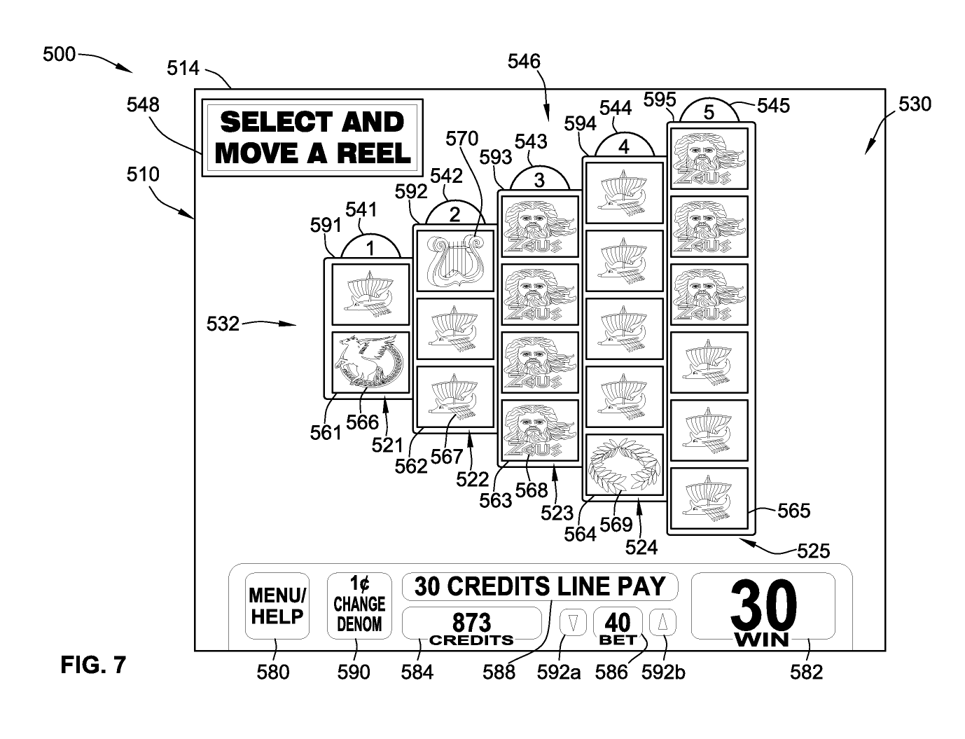

Within the scope of this disclosure, the wagering game 430 can include greater or fewer than five symbol-bearing reels (simulated, mechanical, or otherwise) and, in some embodiments, greater or fewer symbol positions than those shown in FIG. 4. In this regard, the randomly selected outcomes may comprise greater or fewer than 15 symbols, and may take on a variety of different forms having greater or fewer rows and/or columns. The matrix may even comprise other non-rectangular forms or arrangements of symbols, such as those shown in FIGS. 7-10. Moreover, the randomly selected outcomes of the wagering game 430 may be varied from the representation provided in FIG. 4. Likewise, the Ancient Greek Mythology game theme is purely illustrative and non-limiting in nature.

The primary display 414 further includes certain display features for providing information and options to a player. For example, the display 414 features may include a MENU/HELP button 480, a WIN meter 482, a CREDITS meter 484, a BET meter 486, and a LINE PAY meter 488. The MENU/HELP button 480 can be pressed and activated (e.g., through an overlying touch screen) by a player desiring to access other control menus, preferences, help screens, informational menus, etc. For example, the player can change a theme of the wagering game 530 via the MENU/HELP button 580, or change the type of the wagering game (e.g., to video poker, keno, etc.). The WIN meter 482 displays to the player the amount of the total win (if any) from the most recent play of the wagering game 430. The CREDITS meter 484 displays to the player the total amount of credits (if any) remaining and available to the player for play of the wagering game 430. The BET meter 486 displays to a player the current size of his/her wager (in credits). The LINE PAY meter 488 displays the number of credits won by a particular winning symbol combination on a particular payline. Once a number of paylines are selected and a wager is placed, a SPIN button (not shown) can be pressed or otherwise activated by a player to effectuate rotation of the reels 421-425. In an optional configuration, selection of a SPIN button will effectuate rotation of the reels 421-425 without requiring prior selection of a wager and/or a number of paylines (e.g., a default wager and a default number of payline(s) are automatically chosen upon selection of the SPIN button).

Fewer, additional, or alternative display features may be included for presenting information and/or options to a player. In one specific instance, a row of player-selectable LINES buttons can be provided to give players the option of quickly selecting and activating a predetermined number of paylines (e.g., 1, 5, 9, 20 or 40 lines). Another option would be to display a row of player-selectable PER LINE buttons, which gives a player the option of quickly selecting a predetermined bet per payline (e.g., 1, 2, 3, 5 and 10 credits per activated payline). The primary display 414 can also include, for example, an optional CHANGE DENOM button 490 that can be activated to change the denomination of wagers (e.g., from 250 per credit to $1 per credit) which the player is inputting into the system 400. Other features may include, in some non-limiting examples, one or more bet change buttons 492A and 492B that permit a player to incrementally increase and/or decrease the size of his/her wager, a MAX BET SPIN button (not shown) for wagering a maximum number of credits and contemporaneously varying the reels of the wagering game 430, as well as any of the other buttons and meters presented herein or other features now known or hereinafter developed.

The wagering game 430 is shown in FIG. 4 after play of a base game or bonus game segment is initiated, for example, by the player providing a wager (e.g., responsive to an input via at least one input device) and thereafter pressing a spin button or pulling a spin lever. The monetary wager, which is typically a selected number of credits, is deducted from the available credits, e.g., the 873 credits displayed via the CREDITS meter 484 in FIG. 4. The monetary wager that is in play (e.g., 40 credits in FIG. 4) can be displayed via the BET meter 486. The reels 421-425 may then be varied (e.g., spun and stopped); the reels 421-425 continue to spin until they are stopped to reveal in the symbol array 432 symbols which represent a randomly selected outcome of the wagering game 430. The wagering-game outcome is, according to some aspects, randomly determined from a plurality of potential wagering-game outcomes. As indicated above, each outcome is evaluated for winning symbol combinations—to determine if the displayed outcome has one or more awards associated therewith.

A local controller (e.g., CPU 30 of FIG. 2), a host system (e.g., external system 48 of FIG. 2), a central controller, or any combination thereof, in alternative embodiments, operates to execute the wagering game program causing the display area 414 to display selected portions of the wagering game 430. An outcome of the wagering game can be randomly selected from a plurality of potential wagering-game outcomes (e.g., using a local random number generator (RNG)). The wagering-game outcome is then revealed, displayed, or otherwise communicated to the player, for example, on a corresponding display device 414. In FIGS. 4-6, the game screen 414 displays the wagering-game outcome by portraying the plurality of simulated reels 421-425 spinning and stopping to reveal a plurality of symbols arranged in a 3-row, 5-column matrix—i.e., symbol array 432. A winning combination occurs, for example, when the displayed symbols correspond to one or more of the winning symbol combinations listed in a pay table. In response, a wagering-game prize (e.g., a monetary award) associated with a winning outcome is conferred upon the player.

In the illustrated embodiment, the player is given the option of selectively varying or otherwise modifying the volatility of one or more plays of the wagering game 430, whether it is in the basic portion of the wagering game or a portion of one or more bonus games associated therewith. The primary display device 414 of FIG. 4, for example, presents to the player a plurality of player-selectable volatility-changing reel modifiers, collectively designated 444, each of which is associated with one or more of the symbol-bearing reels 421-425 and is operable to modify, in a distinct manner, the volatility of the next play or set of plays of at least a portion of the wagering game 430.

Each of the player-selectable volatility-changing reel modifiers 444 may be configured to increase or decrease the value of any winning symbol combinations which include one or more symbols on the symbol-bearing reel associated with that selected volatility-changing reel modifier. In some non-limiting examples, the plurality of volatility-changing reel modifiers 444 of FIG. 4 includes three distinct player-selectable award-multiplier tabs: a first award-multiplier tab 440 with a 2× multiplier value is assigned to the third reel 423; a second award-multiplier tab 441 with a 3× multiplier value assigned to the fourth reel 424; and a third award-multiplier tab 442 with a 4× multiplier value assigned to the fifth reel 425. As will be developed in further detail below, the award-multiplier tabs 440-442 multiply the award value associated with each winning symbol combination which occurs in the next outcome of the wagering game and includes at least one symbol on the symbol-bearing reel associated with the selected volatility-changing award-multiplier tab.

Only a subset of the symbol-bearing reels 421-425 of FIG. 4 is associated with the player-selectable volatility-changing reel modifiers 444. It is, however, within the scope and spirit of the present disclosure to increase or decrease the number of award-multiplier tabs 440-442 from what is shown in the drawings. For instance, the volatility-changing reel modifiers 444 could be changed to include two, four or all of the reels 421-425, as some non-limiting examples. In this regard, the reels to which each tab is assigned, as well as the size of their respective values, may also be varied from what is shown (e.g., based on wager size and/or frequency), so long as the final arrangement comports with the intended aspects of the disclosed concepts. The illustrated multipliers are merely intended as examples of escalating multipliers; it should be understood that the multiplier values can be selected to ensure that the overall payback percentage for the wagering game, regardless of which volatility tab is selected, is substantially the same, in some embodiments. Moreover, the reel-modifying tabs 440-442 may include other reel-modifying features (e.g., bonus-game triggers or progressive-jackpot triggers) that are adapted to affect game volatility.

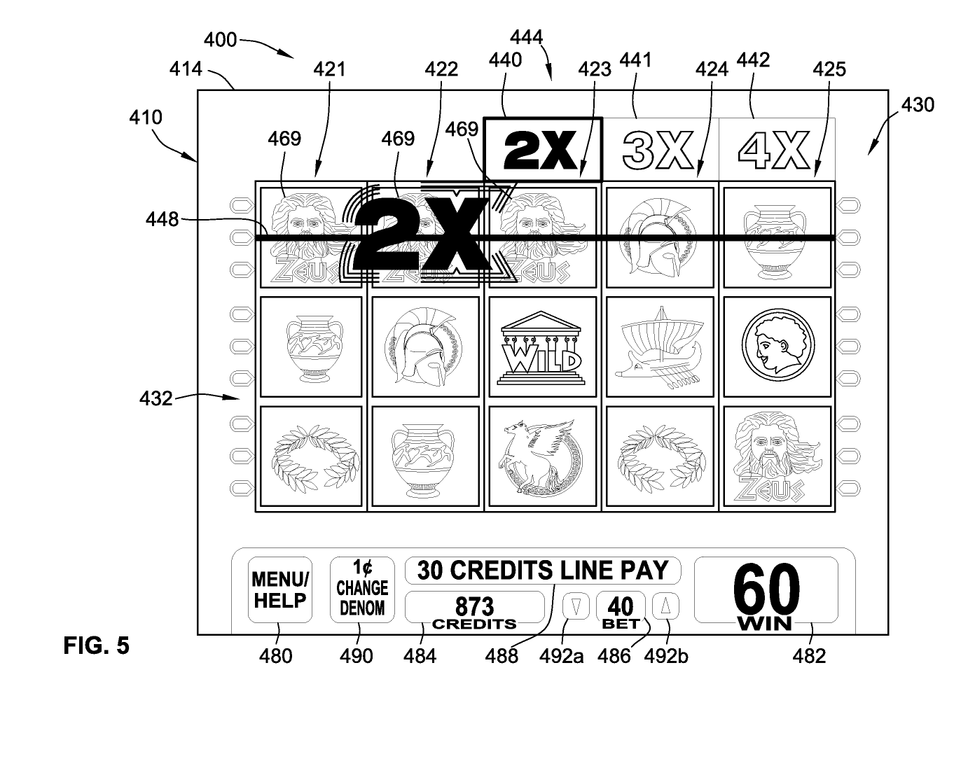

With the player-selectable volatility-changing reel modifiers 444 displayed, the player may be prompted, e.g., via a popup window 446, to SELECT A MULTIPLIER TAB. As seen in FIG. 5, the player has selected the first award-multiplier tab 440. Optional variations may forego a visual or audible prompt; such configurations can require the player to make one or more selections prior to each, every, or only selected plays of the wagering game 430. In some embodiments, only one of the volatility-changing reel modifiers 444 can be selected at a time for the subsequent play of the wagering game 430. Alternative configurations, however, may allow multiple selections. Optionally, the availability to select one or more of the volatility-changing award-multiplier tabs 440-442 may be tied to one or more eligibility requirements or may result from a triggering event in the wagering game. For example, the option to select one or more of the volatility-changing reel modifiers 444 may only be provided in response to the occurrence of a triggering event, such as symbol-based triggers, time-based triggers, wager-based triggers, collection-based triggers, mystery triggers, etc., in or during the basic wagering game. In some embodiments, a player may be required to meet certain eligibility requirements to qualify to select from the volatility-changing award-multiplier tabs 440-442. The eligibility may be based on a number of factors, including acquisition of certain game assets (e.g., a key), reaching certain game milestones (e.g., completing a bonus game), exceeding a certain level of wagering activity, and the like. In some embodiments, other aspects of the wagering game 430 may be reconfigured to maintain a certain overall volatility or a certain overall expected value for the wagering game 430.

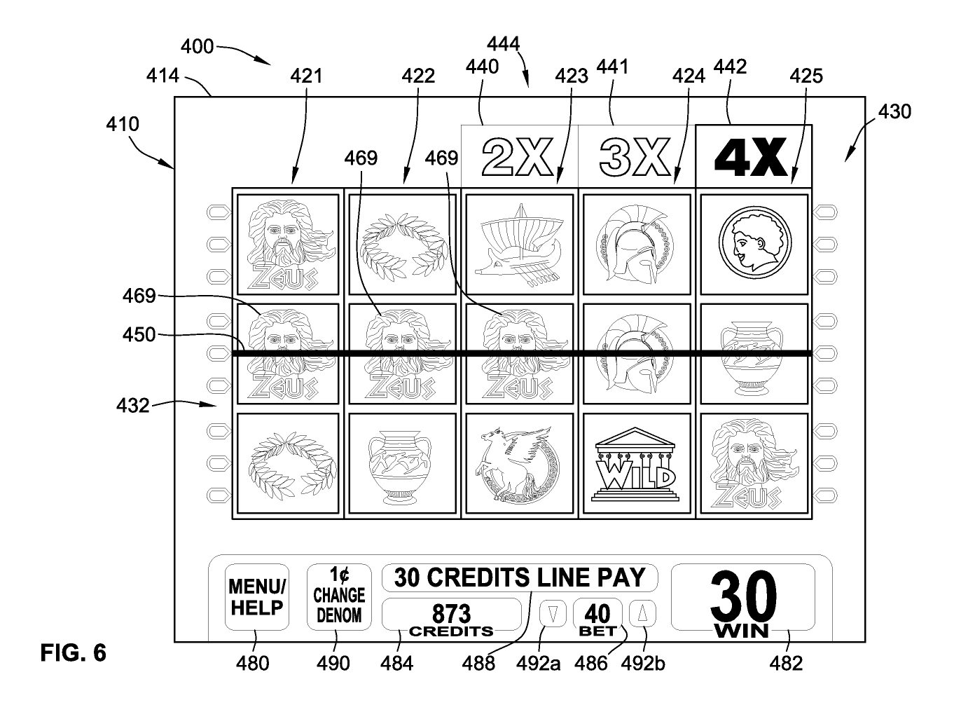

Once selected, the volatility of one or more subsequent plays of the wagering game 430 is altered in a specific manner associated with the selected volatility-changing reel modifier (e.g., the first award-multiplier tab 440 in FIG. 5). Continuing with the illustrated example, the symbol-bearing reels 421-425 are displayed via the primary display device 414 of FIGS. 4-6 each with a vertical orientation and collectively arranged side-by-side, e.g., in a left-to-right horizontal arrangement. One or more active paylines (e.g., paylines 58 of FIG. 3, winning payline 448 in FIG. 5, and winning payline 450 in FIG. 6) extend, e.g., from left-to-right, through the symbol-bearing reels 421-425. In the illustrated embodiment, winning outcomes are evaluated on a left-to-right line pay scheme, where payline-based winning symbol combinations start on the first reel 421 and span from the left to the right across the array 432 to the adjacent reels 422-425. In alternative implementations, the winning combinations start from either the first reel (“left-to-right”) and/or the fifth reel (“right-to-left”) and span to the adjacent reels. It may be further required, for example, in applications with a 5-column array, that each payline-based winning symbol combination include at least three symbols, including one symbol on each of the first three reels 421-423. In this instance, the award-multiplier tabs 440-442 start at the third reel 423 from the left, and increase in value from left-to-right.

Using the foregoing arrangement, the award-multiplier tabs 440-442 increase the volatility of the wagering game 430, and the larger the multiplier associated with the selected tab, the larger the increase in volatility. By way of clarification, and not limitation, if the player selects the lowest available multiplier (e.g., the first volatility-changing award-multiplier tab 440 with the 2× multiplier), every payline-based winning symbol combination will achieve the 2× multiplier because all of the line pays in this implementation would necessarily include a symbol on the third reel 423. This is the low-volatility option, since the multiplier value is the smallest of the available selections, but the frequency of payout is the highest of the available options. If the player selects the second volatility-changing award-multiplier tab 441 with the 3× multiplier, only payline-based winning symbol combinations with at least four symbols will achieve the 3× multiplier assigned to the fourth reel 424. This is the medium-volatility option, since the multiplier value and frequency of occurrence associated with the second award-multiplier tab 441 are higher than that associated with the first award-multiplier tab 440, but lower than that associated with the third award-multiplier tab 442. Contrastingly, if the player selects the highest available multiplier (e.g., the third volatility-changing award-multiplier tab 442 with the 4× multiplier), only payline-based winning symbol combinations with five symbols will achieve the 4× multiplier assigned to the fifth reel 425. This is the high-volatility option, since the multiplier value is the highest of the available selections, but the frequency of the multiplied payout is the lowest of the available options because significantly fewer of the line pays in this implementation would include the requisite five symbols with at least one symbol on the fifth reel 425. In some embodiments, irrespective of which award-multiplier tab 440-442 is chosen, the selection does not affect the hit rate (e.g., unless the reels are changed).

After at least one of the award-multiplier tabs 440-442 is selected and the volatility of one or more subsequent plays of the wagering game is altered correspondingly, a randomly determined outcome of the next play of the wagering game 430 is displayed via the display device 414 and the subsequent-play outcome is evaluated for any winning symbol combinations. For example, in FIG. 5, the player has achieved a winning combination of three ZEUS symbols 469 aligned along payline 448. A 30-credit line pay award is associated with this winning symbol combination, which is shown in the LINE PAY meter 488. Since the first award-multiplier tab 440 was selected and the winning symbol combination includes a Zeus symbol 469 on the third reel 423 (column three, row one of the array 432), the 30-credit line pay award associated with this winning symbol combination is doubled to 60 credits and displayed in the WIN meter 482. In the foregoing example, a 2× multiplier would also be applied to all other 3, 4, and 5-symbol winning combinations, as all of these combinations necessarily extend through the third reel 423 in the left to right evaluation scheme. By way of contrast, if the player were to have selected the third volatility-changing award-multiplier tab 442 associated with the fifth reel 425, as seen in FIG. 6, a 4× multiplier is applied only to 5-symbol wins. However, since the player has only achieved a winning combination of three ZEUS symbols 469 aligned along payline 450 of FIG. 6, the 30-credit line pay award associated with this winning symbol combination is not multiplied.

As indicated above, the player-selectable volatility-changing reel modifiers 444 may take on different forms and may include other reel-modifying features (e.g., bonus-game triggers or progressive-jackpot triggers) that are adapted to affect game volatility. For such features to affect volatility, the selected reel modifier may need to be adapted to change a factor in left-to-right (or right-to-left) line pay scheme. Examples might include volatility-changing reel modifiers that toggle symbols to and/or from WILD. For example, selection of the third reel tab 425 can operate to change all Pegasus, vase and ship symbols 466, 467 and 468, respectively to WILD symbols; selection of the second reel tab 425 operates to change only Pegasus and ship symbols 466 and 468 to WILD symbols; while selection of the first reel tab makes A WILD only. Each of these player-selectable volatility-changing reel modifiers acts as a “distinct symbol converter” which operates to change one or more selected symbol types on the symbol-bearing reel associated with the selected reel modifier and thereby increase the probability that the next play of the wagering game will include a winning symbol combination with a symbol on the reel associated with the selected reel modifier. Other examples might include bonus or progressive jackpot triggers. For instance, each of the player-selectable volatility-changing reel modifiers (e.g., tabs 440-442) can be assigned a distinct “progressive-jackpot trigger” which awards a respective progressive jackpot or initiates a respective bonus game in response to the next play of the wagering game including a winning symbol combination with a symbol on the symbol-bearing reel associated with the selected reel modifier.

Turning next to FIG. 7, a screen shot of a game screen from an exemplary wagering game is illustrated in accordance with aspects of the present disclosure. A primary display 514 of a gaming device or terminal 510, which may be part of an exemplary gaming system 500, is shown in FIG. 7. The gaming system 500 and gaming terminal 510 of FIG. 7 can take on any of the various forms, optional configurations, and functional alternatives described with respect to the other embodiments presented herein, and thus can include any of the corresponding options and features. For instance, the primary display 514 of the gaming terminal 510 displays wagering games, including any of those described above with respect to FIGS. 1-6 or those described below with respect to FIGS. 7-11.

The display 514 includes a display of a wagering game 530, which in this example is the multi-reel slot game shown in FIG. 7. The wagering game 530 includes a plurality of vertically oriented, horizontally aligned symbol-bearing reels 521-525, each of which has a plurality of distinct symbol positions (collectively represented by five symbol positions 561-565 in FIG. 7) and bearing an array of symbols (collectively represented by five symbols 566-570 in FIG. 7). The symbols may include any variety of graphical symbols, emblems, elements, or representations, including symbols that are associated with one or more themes (e.g., a Greek Mythology theme) of the gaming terminal 510 or system 500. The symbols may also include a blank symbol or empty space. Some of the symbols in the wagering game 530 of FIG. 7 may be grouped into a corresponding clump of symbols. Similar to the wagering games discussed above, the reels 521-525 are varied (e.g., spun and stopped) to reveal combinations of symbols, which represent randomly selected outcomes of the wagering game 530, that are evaluated for winning combinations. Winning combinations of symbols landing on activated paylines (those paylines for which a wager has been received), cause awards to be paid in accordance with one or more pay tables associated with the gaming system 500, for example.

The primary display 514 further includes certain display features for providing information and options to a player. The display features of FIG. 7 may include a MENU/HELP button 580, a WIN meter 582, a CREDITS meter 584, a BET meter 586, a LINE PAY meter 588, and bet change buttons 592A and 592B, each of which may be configured similarly to the corresponding button or meter described above with respect to FIG. 4. Fewer, additional or alternative display features may be included for presenting information/options to a player.

Each of the reels 521-525 in the wagering game 530 of FIG. 7 is associated with a respective distinctly-sized window 591-595. In particular, each window 591-595 is sized to correspond to a predetermined number of symbol positions. One or more of the windows 591-595 may be arranged such that the symbols shown therethrough form an array or matrix of symbols having a number of rows and columns. In the wagering game 530 shown in FIG. 7, however, the symbols on the reels 521-525 do not form a traditional matrix of symbols having a set number of rows, like the array 432 shown in FIGS. 4-6. Rather, in accordance with some aspects of the present disclosure, two or more of the windows 591-595 display a different number of the symbol positions therethrough. For instance, the first window 591, which is to the left of and immediately adjacent to the second window 592, displays two symbol positions of the first reel 52. Likewise, the second window 592, which is in between and immediately adjacent to the first and third windows 591, 593, displays three symbol positions of the second reel 522. Similarly, the third window 593, which is in between and immediately adjacent to the second and fourth windows 592, 594, displays four symbol positions of the third reel 523. The fourth window 592, which is in between and immediately adjacent to the third and fifth windows 593, 595, displays five symbol positions of the fourth reel 524. Finally, the fifth window 595, which is to the right of and immediately adjacent to the fourth window 594, displays six symbol positions of the fifth reel 525. In the illustrated embodiment, each symbol position bears a single symbol; however, it is possible for a single symbol to occupy multiple positions.

At least a portion of one or more of the wagering game outcomes is represented by a segment of each reel 521-525 being displayed through a respective one of the windows 521-525. That is, after the reels 521-525 are varied (e.g., spun and stopped), a segment of the first reel 521 is displayed in the first window 591, a segment of the second reel 522 is displayed in the second window 592, a segment of the third reel 523 is displayed in the third window 593, a segment of the fourth reel 524 is displayed in the fourth window 594, and a segment of the fifth reel 525 is displayed in the fifth window 595. Fewer or additional windows and reels than those shown in FIG. 7 may be included in the wagering game 530. In alternate configurations, the windows 591-595 may individually or collectively display greater or fewer symbols. Recognizably, a delineable window being displayed via the display 514 is not necessarily required to effectuate the premise of the windows 591-595; rather, the display 514 revealing a selected portion of each reel 521-525 as a collective representation of an outcome to the wagering game 530 can suffice.

In the illustrated embodiment, the player is given the option of selectively varying or otherwise modifying the volatility of one or more plays of the wagering game 530, whether it is in the basic portion of the wagering game or a portion of one or more bonus games associated therewith. The primary display device 514 of FIG. 7, for example, presents to the player a plurality of player-selectable volatility-changing reel modifiers, collectively designated 546. Each of the player-selectable volatility-changing reel modifiers 546 is associated with one or more of the symbol-bearing reels 521-525 and is operable to modify, in a distinct manner, the volatility of the next play or set of plays of at least a portion of the wagering game 530.

As shown in FIG. 7, the plurality of volatility-changing reel modifiers 546 includes five player-selectable reel-moving tabs: a first reel-moving tab 541 is assigned to the first reel 521; a second reel-moving tab 542 is assigned to the second reel 522; a third reel-moving tab 543 is assigned to the third reel 521; a fourth reel-moving tab 544 is assigned to the fourth reel 524; and, a fifth reel-moving tab 545 is assigned to the fifth reel 525. Each of the volatility-changing reel-moving tabs 541-545, once selected, operates to move the respective symbol-bearing reel 521-525 and/or the corresponding distinct-sized window 591-595 associated therewith to a new location. The new location of the reel/window may be chosen by the player or, alternatively, may be determined by a CPU and/or an RNG. Optional configurations may omit a visual depiction of the five reel-moving tabs 541-545; rather, the player may just directly select and move the reels 521-525, e.g., via a touch screen 18 of FIG. 1 or other input device. It is within the scope and spirit of the present disclosure to change the number of reel-moving tabs 541-545 from what is shown in FIG. 7. By way of non-limiting example, it is envisioned that only a subset of the symbol-bearing reels 521-525 be associated with the player-selectable volatility-changing reel modifiers 546.

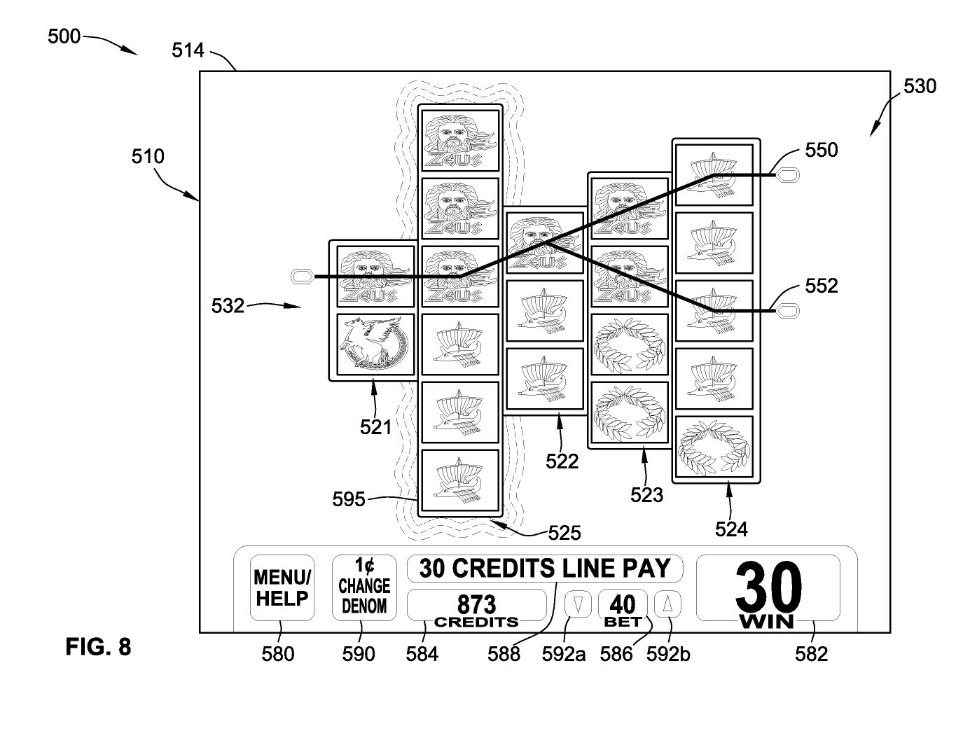

After a wager is placed and one or more of the volatility-changing reel modifiers 546 are presented for selection, the player may be prompted, e.g., via a popup window 548, to SELECT AND MOVE A REEL. As seen in FIG. 8, for example, the player has selected the fifth tab 545 and, thus, the fifth reel 525. Optional variations may forego a visual or audible prompt; such configurations can require the player to make one or more selections prior to each, every, or only selected plays of the wagering game 530. In some embodiments, only one of the volatility-changing reel modifiers 546 can be selected at a time for the subsequent play of the wagering game 530. Alternative configurations, however, may allow multiple selections. Optionally, the availability to select one or more of the volatility-changing award-multiplier tabs 541-545 may be tied to one or more eligibility requirements or may result from a triggering event in the wagering game. In some embodiments, the other (non-selected) symbol-bearing reels and/or the payouts of the wagering game 530 may be reconfigured to maintain a certain overall volatility for the wagering game 530.

Once selected, the volatility of one or more subsequent plays of the wagering game 530 is altered in a specific manner associated with the selected volatility-changing reel modifier (e.g., the fifth reel-moving tab 545 in FIG. 7). Similar to the arrangement depicted in FIG. 4, the symbol-bearing reels 521-525 are displayed via the primary display device 514 of FIGS. 7-10 each with a vertical orientation and collectively arranged side-by-side, e.g., in a left-to-right horizontal arrangement. One or more active paylines (e.g., winning paylines 550, 552 in FIG. 7) extend, e.g., from left-to-right, through the symbol-bearing reels 521-525. In the illustrated embodiment, winning outcomes are evaluated on a left-to-right line pay scheme. It may be further required that each payline-based winning symbol combination include at least three symbols, including one symbol on each of the three left-most reels, shown in FIG. 8, for example, as the first, fifth and second reels 521, 525, 522.

The volatility-changing reel modifiers 546 increase or decrease the volatility of the wagering game 430 depending on the new location to which the selected reel is repositioned. For instance, the new location of the respective symbol-bearing reel(s) can increase or decrease the probability that the outcome of the next play of the wagering game 530 will include at least one winning symbol combination. Optionally, the new location of the selected reel can operate to increase or decrease the total number of winning symbol combinations in the outcome of the next play of the wagering game 530. As another possible option, the new location of the selected reel can increase or decrease the expected award in the outcome of the next play of the wagering game 530. As a baseline for comparison purposes, the reel and window arrangement in FIG. 7 provides a highly volatile game, as the odds of forming one or more winning paylines are relatively low, but when winning paylines are formed, they are typically formed in groups of winning paylines; as such, when the player achieves a winning outcome in the wagering game 530, the total award is relatively high. Alternatively, if the order of the reels 521-525 is reversed—i.e., arranged in order of decreasing size from left-to-right with the fifth reel 525 in the left-most position and the first reel 521 in the right-most position, the wagering game 530 has a much lower volatility because the likelihood of forming winning paylines is much greater (now have 15 symbols in the first three columns as opposed to only 9 symbols in the arrangement of FIG. 7), though, when winning paylines are formed, there are fewer winning paylines, on average.

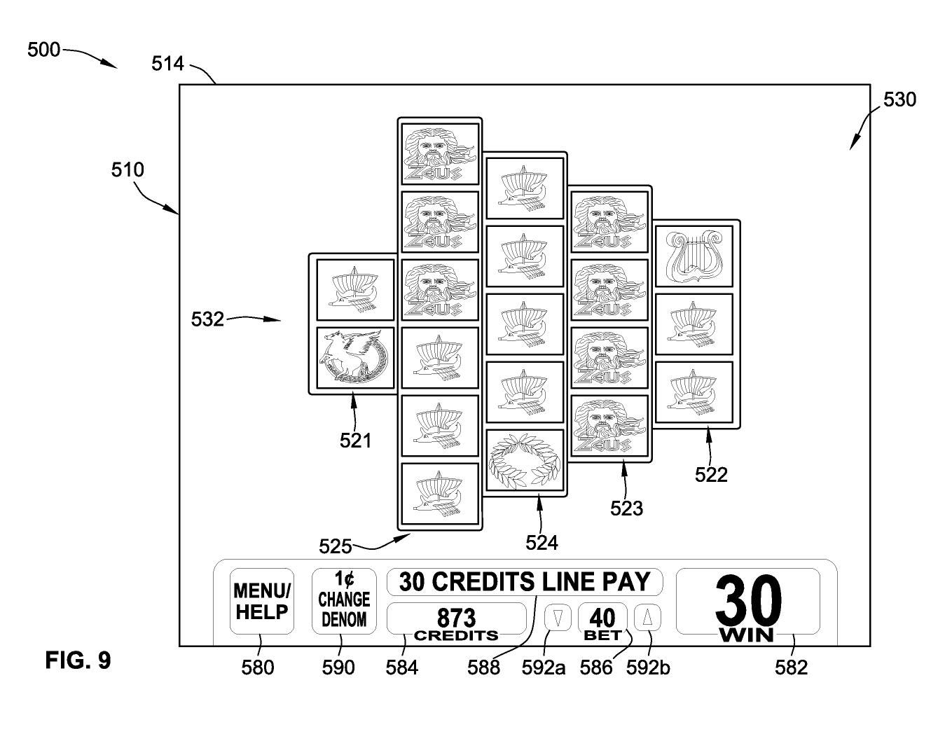

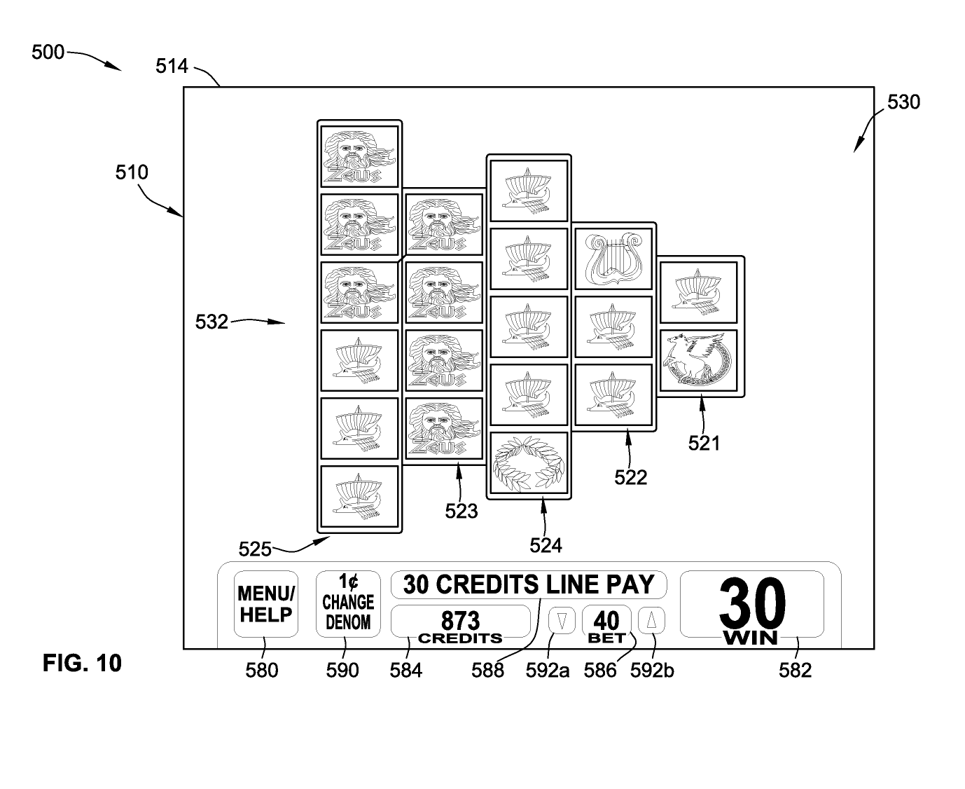

In the example shown in FIG. 8, the player selected the fifth reel-moving tab 545 and, thus, the fifth reel 525 and fifth window 595. The fifth reel 525 and window 595 were moved from the last, right-most position in the array 532 (FIG. 7), to the second-to-left-most position in the array 532 (FIG. 8). By changing the location of the reel 525 and window 595 in such a manner, the player changes the volatility of their gaming experience. Once the fifth reel 525 and window 595 have been selected and moved, some implementations of the disclosed concepts will reposition the remaining reels 521-524. For example, as seen in FIG. 9, the second, third and fourth reels 522-524 were rearranged in order of decreasing size from left-to-right. Alternatively, the player could be allowed to select which column in the array 532 to place all five of the symbol-bearing reels 521-525, or a subset of the symbol-bearing reels 521-525. For example, FIG. 10 illustrates an example of where the player has selected a new location for all of the reels, as follows: fifth reel 525, first column of the array 532; third reel 523, second column of the array 532; fourth reel 524, third column of the array 532; second reel 522, fourth column of the array 532; and, first reel 521, fifth column of the array 532.

To implement the foregoing volatility adjustment may require altering the associated rules, parameters, or other characteristics of the wagering games 430, 530, such as paytables, reel strip layouts, or other game rules (e.g., bonus triggering event), to offset the change in volatility. In some embodiments, no matter the configuration of the reels or the multiplier selected by the player, the overall payback percentage of the wagering games 430, 530 as a whole should remain substantially constant. Additional aspects of the disclosed concepts may also include displaying or otherwise informing the player of the change in volatility. In this vein, a tutorial may be provided to facilitate the players understanding of the concept of volatility, variable volatility, and/or what will be effect of the player's selection(s).

Some embodiments may use trackpad technology or similar haptic and non-haptic technology to provide a slide bar next to the array or the buttons and meters that allows the player to select the volatility. For example, the player would use a finger to move the slide bar between low, medium and high volatility selections or, alternatively, to select a specific numeral representation of the volatility. When the player moves the slide bar, a corresponding slide bar can be displayed at the bottom of the video screen to graphically represent the player's selection. Alternatively, on a video reel game, the slide bar could be a thin strip located parallel to the video reels, and could behave like a thermometer—e.g., high volatility could be represented by a red line that extends from the top of the reel to the bottom of the reels, medium volatility is a red line that extends from the bottom of the reels to the middle height of the reels, and low volatility is a red line that extends from the bottom of the reels to about ⅓ way up the reels. Optional arrangements could employ a volatility dial around the EGM's circular repeat-bet button that allows the player to adjust the volatility. During idle mode, the player can rotate the dial. This can operate to bring up a dynamic paytable display on the screen. Turning up volatility will increase the value of high pay symbol combinations and simultaneously decrease the value of low pay symbols combinations.

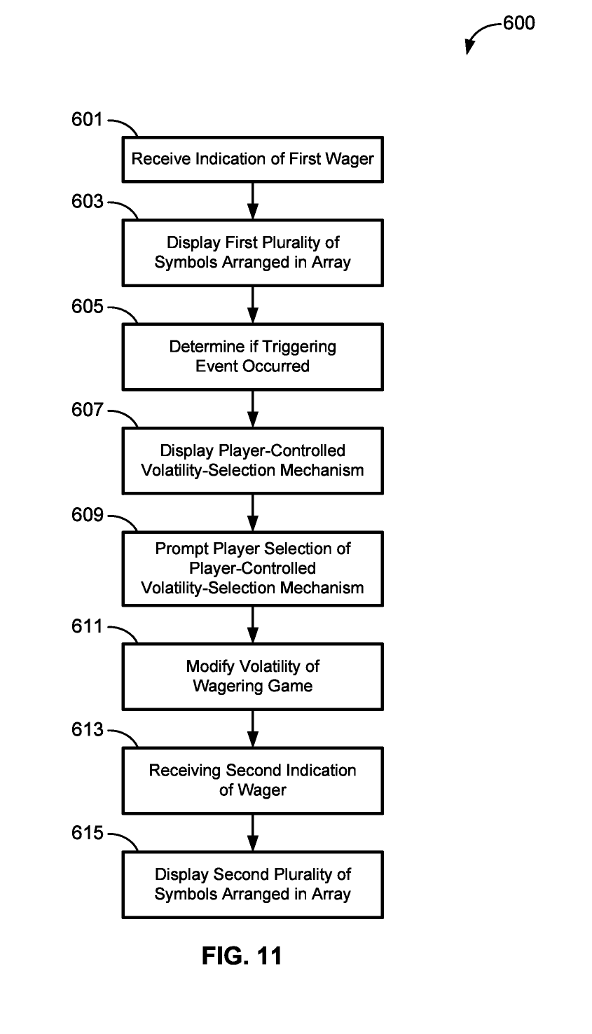

With reference now to the flow chart of FIG. 11, an improved method for conducting a wagering game on a gaming terminal or gaming device, such as the gaming terminal 10 shown in FIG. 1, and/or a gaming system, such as the gaming system shown in FIG. 2, is generally described at 600 in accordance with aspects of the present disclosure. FIG. 11 can be representative of an algorithm that corresponds to at least some instructions that can be stored, for example, in main memory 32 of FIG. 2, and executed, for example, by the CPU 30 and/or external system(s) 48 of FIG. 2 to perform any or all of the above or below described functions associated with the disclosed concepts. The method 600 will be described with reference to the various aspects and features shown in FIGS. 4-10 of the drawings; such reference is being provided purely by way of explanation and clarification.

The method 600 begins at block 601 by receiving (e.g., via an input device such as touch screen 18, bill validator 22, information reader/writer 24, etc.) an indication of a wager to play a wagering game. At block 603, an outcome of the wagering game is displayed, for example, as a plurality of symbols arranged in an array, such as symbol array 432 of FIG. 4 or symbol array 532 of FIG. 7. This may include, as indicated above, an RNG generating a random number, game logic for determining the outcome based on the randomly generated number, and the CPU 42, the external system 48, or both, in alternative embodiments, operating to execute a wagering game program, and game assets (e.g., art, sound, etc.) for presenting the determined outcome to a player in a visual manner.

At block 605, the method 600 optionally determines whether a triggering event occurred in the wagering game and, if so, will display one or more player-controlled volatility-selection mechanisms at block 607. As indicated above, the availability to select one or more of the volatility-changing award-multiplier tabs 440-442 of FIG. 4 or move one or more of the reels 521-525 in FIG. 7 may be tied to one or more eligibility requirements or may result from one or more triggering events in the wagering games 430, 530. Alternative configurations, however, may allow for any/all selections to be made without a preceding triggering event or a prior determination of eligibility.

With the player-controlled volatility-selection mechanisms displayed, the player may be prompted, e.g., via popup windows 446, 548 of FIGS. 4 and 7, respectively, to select one or more of the displayed volatility-selection mechanisms, as seen in block 609. Responsive to the selection, the volatility of one or more subsequent plays of the wagering game 430, 530 is altered at block 611 in a distinct manner associated with the selected volatility-changing mechanism(s). At this juncture, the player may be asked to input a second wager, e.g., at block 613, to initiate the next play of the wagering game 430, 530. After at least one of the player-controlled volatility-selection mechanisms is selected (e.g., block 609) and the volatility of one or more subsequent plays of the wagering game is altered correspondingly (e.g., block 611), a randomly determined outcome of the next play of the wagering game 430, 530 is displayed via the display device 414, 514 and evaluated for any winning symbol combinations at block 615.

In some embodiments, the method 600 includes at least those steps enumerated above. It is also within the scope and spirit of the present invention to omit steps, include additional steps, and/or modify the order presented above. It should be further noted that the method 600 represents a single play of a wagering game. However, it is expected that the method 600 be applied in a systematic and repetitive manner.

Aspects of this disclosure can be implemented, in some embodiments, through a computer-executable program of instructions, such as program modules, generally referred to as software applications or application programs executed by a computer. The software can include, in non-limiting examples, routines, programs, objects, components, and data structures that perform particular tasks or implement particular abstract data types. The software can form an interface to allow a computer to react according to a source of input. The software can also cooperate with other code segments to initiate a variety of tasks in response to data received in conjunction with the source of the received data. The software can be stored on any of a variety of memory media, such as CD-ROM, magnetic disk, bubble memory, and semiconductor memory (e.g., various types of RAM or ROM).

Moreover, aspects of the present disclosure can be practiced with a variety of computer-system and computer-network configurations, including hand-held devices, multiprocessor systems, microprocessor-based or programmable-consumer electronics, minicomputers, mainframe computers, and the like. In addition, aspects of the present disclosure can be practiced in distributed-computing environments where tasks are performed by remote-processing devices that are linked through a communications network. In a distributed-computing environment, program modules can be located in both local and remote computer-storage media including memory storage devices. Aspects of the present disclosure can therefore, be implemented in connection with various hardware, software or a combination thereof, in a computer system or other processing system.

Any of the methods described herein can include machine readable instructions for execution by: (a) a processor, (b) a controller, and/or (c) any other suitable processing device. Any algorithm, software, or method disclosed herein can be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it can be implemented by an application specific integrated circuit (ASIC), a programmable logic device (PLD), a field programmable logic device (FPLD), discrete logic, etc.). Also, some or all of the machine readable instructions represented in any flowchart depicted herein can be implemented manually. Further, although specific algorithms are described with reference to flowcharts depicted herein, persons of ordinary skill in the art will readily appreciate that many other methods of implementing the example machine readable instructions can alternatively be used. For example, the order of execution of the blocks can be changed, and/or some of the blocks described can be changed, eliminated, or combined.

It should be noted that the algorithms illustrated and discussed herein as having various modules or blocks or steps that perform particular functions and interact with one another are provided purely for the sake of illustration and explanation. It should be understood that these modules are merely segregated based on their function for the sake of description and represent computer hardware and/or executable software code which can be stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While many representative embodiments and exemplary modes for carrying out the present invention have been described in detail above, those familiar with the art to which this invention relates will recognize various alternative designs and embodiments for practicing the invention within the scope of the appended claims.

What is claimed is:

1. A gaming system for playing a wagering game, the gaming system comprising:
at least one input device;
at least one display device;
at least one processor; and
at least one memory device storing instructions which, when executed by the at least one processor, cause the gaming system to:
receive a wager to play the wagering game, the wagering game including a plurality of symbol-bearing reels;
display a plurality of player-selectable volatility-changing reel modifiers, each of the volatility-changing reel modifiers being selectable by a player, associated with a respective one of the symbol-bearing reels, and configured to modify a volatility of a subsequent play of the wagering game in a distinct manner;
receive from a player a selection of at least one of the player-selectable volatility-changing reel modifiers;
modify the volatility of the subsequent play of the wagering game according to the distinct manner associated with the selected volatility-changing reel modifier;
display a randomly determined outcome of the subsequent play of the wagering game; and
determine if the subsequent-play outcome includes at least one of a plurality of winning symbol combinations.

2. The gaming system of claim 1, wherein each of the player-selectable volatility-changing reel modifiers increases or decreases a value associated with each of the winning symbol combinations in the subsequent-play outcome which includes a symbol on the symbol-bearing reel associated with the selected volatility-changing reel modifier.

3. The gaming system of claim 2, wherein each of the player-selectable volatility-changing reel modifiers is a distinct award multiplier which multiplies the value associated with each of the winning symbol combinations in the subsequent-play outcome which includes a symbol on the symbol-bearing reel associated with the selected volatility-changing reel modifier.

4. The gaming system of claim 3, wherein the plurality of symbol-bearing reels are displayed on the at least one display device arranged in an array from left-to-right, and wherein the award multipliers increase in value from left-to-right.

5. The gaming system of claim 4, wherein the wagering game includes at least one active payline extending through the plurality of symbol-bearing reels, and wherein the determining if the subsequent-play outcome includes at least one winning symbol combination is determined by evaluating the at least one active payline on a left-to-right line pay scheme.

6. The gaming system of claim 2, wherein only a subset of the plurality of symbol-bearing reels is associated with the player-selectable volatility-changing reel modifiers.

7. The gaming system of claim 1, wherein each of the player-selectable volatility-changing reel modifiers is a distinct symbol converter which changes one or more predetermined symbol types on the symbol-bearing reel associated with the selected volatility-changing reel modifier to thereby increase the probability that the subsequent-play outcome will include a winning symbol combination with a symbol on the symbol-bearing reel associated with the selected volatility-changing reel modifier.

8. The gaming system of claim 1, wherein each of the player-selectable volatility-changing reel modifiers is a distinct progressive-jackpot trigger which awards a respective progressive jackpot in response to the subsequent-play outcome including a winning symbol combination with a symbol on the symbol-bearing reel associated with the selected volatility-changing reel modifier.

9. The gaming system of claim 1, wherein each of the player-selectable volatility-changing reel modifiers moves the respective symbol-bearing reel associated with the selected volatility-changing reel modifier to a new location.

10. The gaming system of claim 9, wherein the new location of the respective symbol-bearing reel is chosen by the player.

11. The gaming system of claim 9, wherein the new location of the respective symbol-bearing reel increases or decreases a probability that the subsequent-play outcome will include at least one of the plurality of winning symbol combinations.

12. The gaming system of claim 9, wherein the new location increases or decreases a total number of winning symbol combinations in the subsequent-play outcome.

13. The gaming system of claim 9, wherein the wagering game further includes a plurality of distinct-sized windows each of which corresponds to a respective one of the symbol-bearing reels, the subsequent-play outcome being represented by a segment of each symbol-bearing reel being displayed through its corresponding distinct-sized window, each of the volatility-changing reel modifiers moving the corresponding distinct-sized window to the new location with the respective symbol-bearing reel.

14. The gaming system of claim 9, wherein the wagering game includes at least one active payline extending through the plurality of symbol-bearing reels, and wherein the determining if the subsequent-play outcome includes at least one winning symbol combination is determined by evaluating the at least one active payline on a left-to-right line pay scheme.

15. The gaming system of claim 9, wherein, responsive to the selected volatility-changing reel modifier moving the respective symbol-bearing reel to the new location, one or more of the other symbol-bearing reels are moved to respective different locations.

16. The gaming system of claim 1, wherein only one of the player-selectable volatility-changing reel modifiers can be selected by the player for the subsequent play.

17. A method of conducting a wagering game on a gaming system with at least one input device, at least one display device, and at least one processor, the wagering game including a plurality of symbol-bearing reels, the method comprising:
receiving, via the at least one input device, an indication of a wager;
displaying, via the at least one display device, a plurality of player-selectable volatility-changing reel modifiers, each of the player-selectable volatility-changing reel modifiers being associated with a respective one of the symbol-bearing reels and configured to modify a volatility of a subsequent play of the wagering game in a distinct manner;
receiving, via the at least one input device, a player selection of at least one of the player-selectable volatility-changing reel modifiers;
modifying, via the at least one processor, the volatility of the subsequent play of the wagering game according to the distinct manner associated with the selected volatility-changing reel modifier;
displaying, via the at least one display device, a randomly determined outcome of the subsequent play of the wagering game; and
determining, via the at least one processor, if the subsequent-play outcome includes at least one of a plurality of winning symbol combinations.

18. The method of claim 17, wherein each of the player-selectable volatility-changing reel modifiers increases an award value associated with each of the winning symbol combinations in the subsequent-play outcome which includes a symbol on the symbol-bearing reel associated with the selected volatility-changing reel modifier.

19. The method of claim 18, wherein each of the player-selectable volatility-changing reel modifiers is a distinct award multiplier which multiplies the award value associated with each of the winning symbol combinations in the subsequent-play outcome which includes a symbol on the symbol-bearing reel associated with the selected volatility-changing reel modifier.

20. The method of claim 19, wherein the plurality of symbol-bearing reels are displayed on the at least one display device arranged in an array from left-to-right, at least one active payline extends through the plurality of symbol-bearing reels, the award multipliers increase in value from left-to-right, and the determining if the subsequent-play outcome includes at least one winning symbol combination is determined by evaluating the at least one active payline on a left-to-right line pay scheme.

21. The method of claim 17, wherein each of the player-selectable volatility-changing reel modifiers allows the player to move the respective symbol-bearing reel associated with the selected volatility-changing reel modifier from a current location to a new location.

22. The method of claim 21, wherein the new location increases a total number of winning symbol combinations in the subsequent-play outcome, increases a probability that the subsequent-play outcome will include at least one of the plurality of winning symbol combinations, or both.

23. A computer program product comprising one or more non-transient computer-readable media including instructions which, when executed by one or more processors, cause the one or more processors to operate with one or more input devices and one or more display devices to:
receive a wager to play the wagering game, the wagering game including a plurality of symbol-bearing reels;
display a plurality of player-selectable volatility-changing reel modifiers, each of the player-selectable volatility-changing reel modifiers being associated with a respective one of the symbol-bearing reels and configured to modify a volatility of a subsequent play of the wagering game in a distinct manner;
receive from a player a selection of at least one of the player-selectable volatility-changing reel modifiers;
modify the volatility of the subsequent play of the wagering game according to the distinct manner associated with the selected volatility-changing reel modifier; and
display a randomly determined outcome of the subsequent play of the wagering game.

24. A gaming system for playing a wagering game, the gaming system comprising:
at least one processor; and
at least one memory device storing instructions which, when executed by the at least one processor, cause the gaming system to:
receive, responsive to a wager input via at least one input device, a wager to play the wagering game, the wagering game including a plurality of symbol-bearing reels arranged in an array from left-to-right;
display, via at least one display device, a plurality of player-selectable volatility-changing reel award multipliers, each of the player-selectable reel award multipliers being assigned to a respective one of the symbol-bearing reels and configured to multiply an award value associated with each winning symbol combination in a subsequent play of the wagering game which includes a symbol on the symbol-bearing reel assigned to the selected volatility-changing reel award multiplier;
receive, responsive to a player input via the at least one input device, a selection of at least one of the volatility-changing reel award multipliers;
display, via the at least one display device, an outcome of the subsequent play of the wagering game, the subsequent-play outcome being randomly determined from a plurality of wagering-game outcomes; and
determine if the subsequent-play outcome includes at least one of a plurality of winning symbol combinations, the determining including evaluating at least one active payline extending through the plurality of symbol-bearing reels on a left-to-right line pay scheme.

25. A gaming system for playing a wagering game, the gaming system comprising:
at least one processor; and
at least one memory device storing instructions which, when executed by the at least one processor, cause the gaming system to:
receive, responsive to a wager input via at least one input device, a wager to play the wagering game, the wagering game including a plurality of symbol-bearing reels arranged in an array from left-to-right, and a plurality of distinct-sized windows each of which shows therethrough a portion of a respective one of the symbol-bearing reels;
receive, responsive to a player input via the at least one input device, a selection to move at least one of the symbol-bearing reels and the corresponding distinct-sized window from a current location to a new location;
modifying a volatility of a subsequent play of the wagering game according to the new location of the moved symbol-bearing reel and distinct-sized window;
display, via at least one display device, an outcome of the subsequent play of the wagering game, the subsequent-play outcome being randomly determined from a plurality of wagering-game outcomes; and
determine if the subsequent-play outcome includes at least one of a plurality of winning symbol combinations, the determining including evaluating at least one active payline extending through the plurality of symbol-bearing reels on a left-to-right line pay scheme.
